(19) United States
(12) Patent Application Publication
(10) Pub. No.: US 2025/0349988 A1
(43) Pub. Date: Nov. 13, 2025

(54) CONDUCTIVE MODULE

(71) Applicant: YAZAKI CORPORATION, Tokyo (JP)

(72) Inventors: Masato Tanaka, Makinohara-shi (JP); Tatsuya Oga, Makinohara-shi (JP); Katsunori Sato, Makinohara-shi (JP); Mariko Nakagawa, Makinohara-shi (JP)

(21) Appl. No.: 19/197,971

(22) Filed: May 3, 2025

(30) Foreign Application Priority Data
May 8, 2024 (JP) 2024-075534

(51) Int. Cl. H01M 50/519; H01M 50/507

(52) U.S. Cl. CPC H01M 50/519; H01M 50/507

(57) ABSTRACT

A wiring component includes: a first wiring component, being a flexible printed circuit board formed in a rectangular shape and having a first wiring pattern provided for each of a plurality of busbars of a first busbar group; and a second wiring component, being a flexible printed circuit board formed in a crank shape and having a second wiring pattern provided for each of a plurality of busbars of a second busbar group. The first wiring component is routed so as to allow its longitudinal direction to be aligned with a line-up direction of battery cells and to be close to the first busbar group while maintaining the rectangular shape.

### CROSS-REFERENCE TO RELATED APPLICATION(S)

The present application claims priority to and incorporates by reference the entire contents of Japanese Patent Application No. 2024-075534 filed in Japan on May 8, 2024.

### BACKGROUND OF THE INVENTION

### 1. Field of the Invention

The present invention relates to a conductive module.

### 2. Description of the Related Art

A conductive module includes a battery module in which a plurality of battery cells is lined up, and electrically connects, in the battery module, the plurality of battery cells to each other using a plurality of busbars. The conductive module allows each busbar to be electrically connected to a battery monitoring unit provided to monitor the battery state of the battery cell, using a wiring component such as a flexible printed circuit board (FPC). Here, in the battery module, there are two rows of an aggregate (electrode terminal group) of a plurality of electrode terminals disposed in a line-up direction of the plurality of battery cells, and the electrode terminal and the busbar are connected to each other for each electrode terminal group. For example, the FPC, provided as a wiring component, includes: a trunk line routed between each electrode terminal group; and a branch line branched from the trunk line to one electrode terminal group side and the other electrode terminal group side for each busbar. One end of the trunk line is a connector mounting portion used to mount a connector being provided for achieving a connection using the connector to the battery monitoring unit side. This type of conductive module is disclosed in Japanese Patent Application Laid-open No. 2022-173610 below.

The battery module includes an exhaust duct that communicates with an exhaust valve of each battery cell and releases a gas inside the battery cell discharged from the exhaust valve to the atmosphere. For example, in the battery module, the exhaust duct is disposed between each electrode terminal group. In this case, in the conventional wiring component, since the trunk line undesirably covers the exhaust duct, it is necessary to replace the wiring component with a wiring component avoiding the exhaust duct. A conceivable example of such a countermeasure would be a component including: a first main branch line branched from the connector mounting portion to one electrode terminal group side; a second main branch line branched from the connector mounting portion to the other electrode terminal group side; a first sub-branch line branched from the first main branch line for each busbar on the one electrode terminal group side; and a second sub-branch line branched from the second main branch line for each busbar on the other electrode terminal group side, and configured to route the first main branch line and the second main branch line using a path avoiding the exhaust duct. Here, the FPC is stamped, as a predetermined shape, out of one sheet to be a base material. This causes the FPC as a countermeasure product to have a poor yield, unpreferable from the viewpoint of cost.

### SUMMARY OF THE INVENTION

In view of this, an object of the present invention is to provide a conductive module with a good yield.

A conductive module according to one aspect of the invention includes busbar groups, each group being an aggregate of busbars, the busbar being provided to physically and electrically connect to an electrode terminal of a battery cell constituting a battery module, the busbar groups including a first busbar group having, as a connection target, a plurality of the electrode terminals on one side arranged in a line-up direction of a plurality of the battery cells constituting the battery module and a second busbar group having, as a connection target, a plurality of the electrode terminals on the other side arranged in the line-up direction; a wiring component to electrically connect the busbar to a battery monitoring unit that monitors a battery state of the battery cell; and an electrical connection member for each busbar to physically and electrically connect the wiring component to the busbar, wherein the wiring component includes: a first wiring component being a flexible printed circuit board formed in a rectangular shape and having a first wiring pattern provided for each of the plurality of busbars of the first busbar group; a second wiring component being a flexible printed circuit board formed in a crank shape and having a second wiring pattern provided for each of the plurality of busbars of the second busbar group; and a connector for connecting the first wiring component and the second wiring component to the battery monitoring unit by using the connector, the first wiring component is routed so as to allow its longitudinal direction to be aligned with the line-up direction and to be close to the first busbar group while maintaining the rectangular shape, and the second wiring component includes: a second connector mounting portion on one end side provided so as to be close to a first connector mounting portion on one end side of the first wiring component in a facing placement direction of the first busbar group and the second busbar group; a main path portion on the other end side routed so as to set its longitudinal direction to be aligned with the line-up direction and to be close to the second busbar group; and an intermediate path portion to connect the second connector mounting portion and the main path portion.

A conductive module according to another aspect of the invention includes busbar groups, each group being an aggregate of busbars, the busbar being provided to physically and electrically connect to an electrode terminal of a battery cell constituting a battery module, the busbar group including a first busbar group having, as a connection target, a plurality of the electrode terminals on one side arranged in a line-up direction of a plurality of the battery cells constituting the battery module and a second busbar group having, as a connection target, a plurality of the electrode terminals on the other side arranged in the line-up direction; a wiring component to electrically connect the busbar to a battery monitoring unit that monitors a battery state of the battery cell; and an electrical connection member for each busbar to physically and electrically connect the wiring component to the busbar, wherein the wiring component includes: a first wiring component being a flexible printed circuit board formed in a rectangular shape and having a first wiring pattern provided for each of the plurality of busbars of the first busbar group; a second wiring component being a flexible printed circuit board formed in a rectangular shape and bent in a crank shape having two bent portions and having a second wiring pattern provided for each of the plurality of busbars of the second busbar group; and a connector for connecting the first wiring component and the second wiring component to the battery monitoring unit by using the connector, the first wiring component is routed so as to allow its longitudinal direction to be aligned with the line-up direction and to be close to the first busbar group while maintaining the rectangular shape, and the second wiring component includes: a second connector mounting portion on one end side provided so as to be close to a first connector mounting portion on one end side of the first wiring component in a facing placement direction of the first busbar group and the second busbar group; a main path portion on the other end side routed so as to set its longitudinal direction to be aligned with the line-up direction and to be close to the second busbar group; and an intermediate path portion to connect the second connector mounting portion and the main path portion via the two bent portions.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a plan view for illustrating a conductive module of an embodiment;

FIG. 2 is an exploded plan view illustrating the conductive module of the embodiment;

FIG. 3 is a schematic view illustrating a battery module together with a busbar;

FIG. 4 is an explanatory diagram illustrating a yield of a first wiring component of the embodiment;

FIG. 5 is an explanatory diagram illustrating a yield of a second wiring component of the embodiment;

FIG. 6 is a plan view illustrating a conductive module of a modification;

FIG. 7 is an exploded plan view illustrating the conductive module of the modification; and

FIG. 8 is an explanatory view illustrating a yield of a second wiring component of the modification.

### DETAILED DESCRIPTION OF THE PREFERRED EMBODIMENTS

An embodiment of a conductive module according to the present invention will be described below in detail with reference to the drawings. Note that the present invention is not limited by the embodiment.

### Embodiment

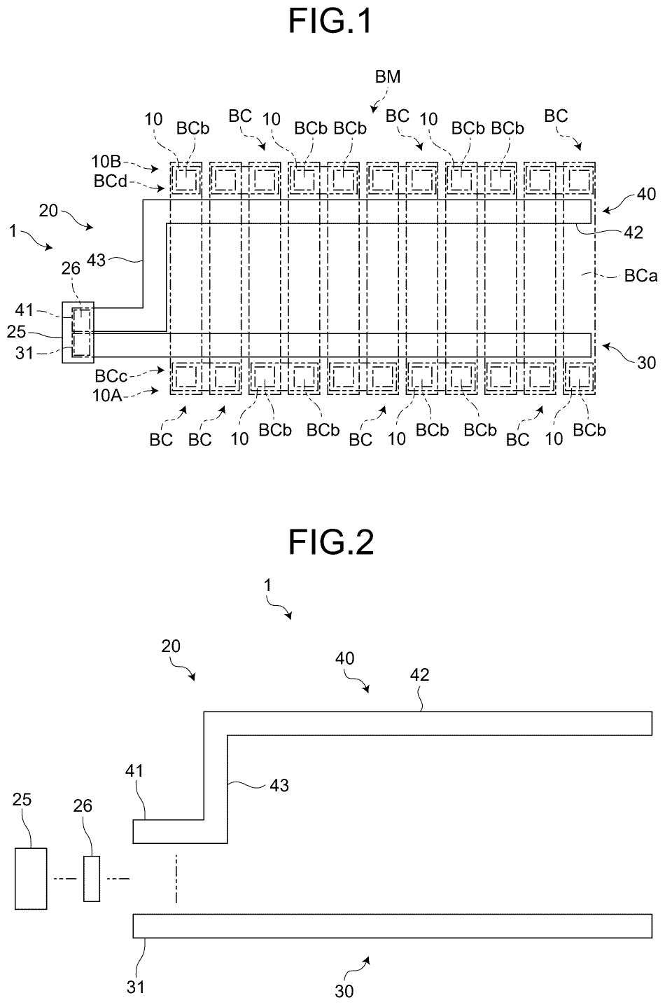

One embodiment of a conductive module according to the present invention will be described with reference to FIGS. 1 to 5.

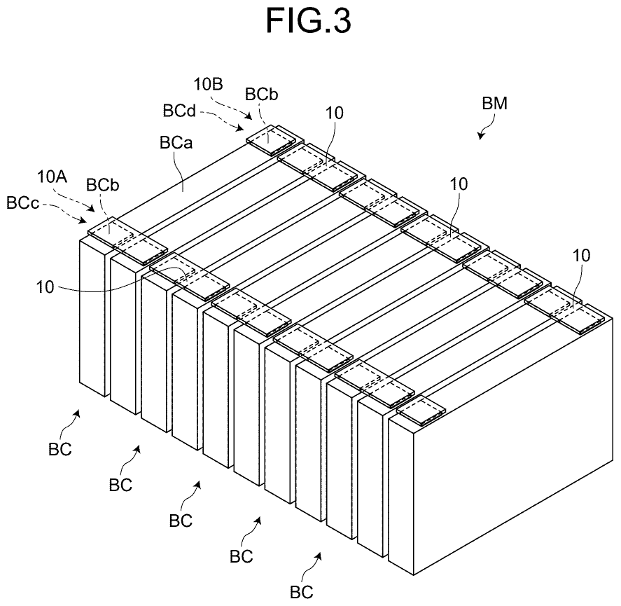

Reference sign 1 in FIGS. 1 and 2 denotes a conductive module (a conductive module 1) of the present embodiment. The conductive module 1 is assembled to a battery module BM (FIGS. 1 and 3) in which a plurality of battery cells BC is lined up (for example, in a single row) so as to electrically connect the plurality of battery cells BC in the battery module BM to each other. The conductive module 1 electrically connects the battery module BM to a battery monitoring unit (not illustrated) to allow the battery monitoring unit to monitor the battery state of the battery cell BC. The conductive module 1, together with the battery module BM, constitute a battery pack. The battery pack is mounted on, for example, a vehicle (such as a Battery Electric Vehicle (BEV) and a Hybrid Electric Vehicle (HEV)) including a rotating machine as a drive source, and is used for purposes such as power supply to the rotating machine.

The battery cell BC includes a cell body BCa and electrode terminals BCb, provided as positive and negative terminals (FIGS. 1 and 3). In the battery cell BC illustrated here, the cell body BCa is formed in a rectangular parallelepiped shape having six outer wall surfaces. In the plurality of battery cells BC constituting the battery module BM, the cell bodies BCa adjacent to each other in the line-up direction are disposed with one outer wall surface facing each other. The battery module BM includes: an aggregate BCc including one of the plurality of electrode terminals BCb disposed in the line-up direction of the plurality of battery cells BC (hereinafter, the one aggregate will be referred to as a “first electrode terminal group” BCc); and an aggregate BCd including the other of the plurality of electrode terminals BCb disposed in the line-up direction of the plurality of battery cells BC (hereinafter, the other aggregate will be referred to as a “second electrode terminal group” BCd) (FIGS. 1 and 3).

Hereinafter, the term “line-up direction”, when described with no other particular explanation, refers to a line-up direction of the plurality of battery cells BC or a line-up direction of the plurality of electrode terminals BCb in the first electrode terminal group BCc and the second electrode terminal group BCd.

In this example, each battery cell BC includes the electrode terminals BCb, including positive and negative electrodes, on one of the six outer wall surfaces of the cell body BCa (FIG. 3). Accordingly, the battery module BM has the first electrode terminal group BCc and the second electrode terminal group BCd provided on one plane (FIG. 3).

In addition, the electrode terminal BCb illustrated here is formed in a flat plate shape, and is to be physically and electrically connected with a busbar 10 to be described below by welding or the like (FIGS. 1 and 3). However, the electrode terminal BCb may be formed in a pole shape having a male screw portion. In this case, the busbar 10 is screwed and fixed to the electrode terminal BCb by screwing a female screw member to the male screw portion of the electrode terminal BCb.

The conductive module 1 has the busbar 10 to be physically and electrically connected to the electrode terminal BCb of the battery cell BC constituting the battery module BM (FIGS. 1 and 3). The conductive module 1 includes busbar groups each of which being an aggregate of the busbars 10, specifically, includes: a first busbar group 10A to be connected to the electrode terminals BCb of the first electrode terminal group BCc, as a connection target; and a second busbar group 10B to be connected to the electrode terminals BCb of the second electrode terminal group BCd, as a connection target.

The busbar 10 is formed of a conductive material such as metal. The busbar 10 is a plate-like conductive component formed of metal, and is press-formed using a metal plate as a base material, for example. The busbar 10 illustrated here is formed in a rectangular flat plate shape.

The conductive module 1 includes, as the busbars 10, for example, a busbar to be physically and electrically connected to the adjacent electrode terminals BCb of the pair of battery cells BC in the battery module BM, a busbar to be physically and electrically connected to the electrode terminal BCb to be a total negative electrode in the battery module BM, and a busbar to be physically and electrically connected to the electrode terminal BCb to be a total positive electrode in the battery module BM.

The conductive module 1 includes a wiring component 20 provided to electrically connect the busbar 10 to the battery monitoring unit (FIGS. 1 and 2). The conductive module 1 includes an electrical connection member (not illustrated) provided, for each busbar 10, to physically and electrically connect the wiring component 20 to the busbar 10. An example of the electrical connection member is a conductive member such as an electric wire or a terminal fitting.

The wiring component 20 includes: a first wiring component 30 for the first busbar group 10A; a second wiring component 40 for the second busbar group 10B; and a connector 25 for connecting the first wiring component 30 and the second wiring component 40 to the battery monitoring unit by using the connector (FIGS. 1 and 2).

The first wiring component 30 is a flexible printed circuit board (FPC) formed in a rectangular shape, and has a first wiring pattern provided for each of the plurality of busbars 10 of the first busbar group 10A. The first wiring component 30 is routed so as to allow its longitudinal direction to be aligned with the line-up direction and so as to be close to the first busbar group 10A while maintaining its rectangular shape.

In the first wiring component 30, the busbar 10 of the adjacent first busbar group 10A is electrically connected with the first wiring pattern paired with the busbar 10. The electrical connection member physically and electrically connects the busbar 10 of the first busbar group 10A and the first wiring pattern, being connection targets, to each other.

The first wiring component 30 has a connector mounting portion (hereinafter, referred to as a “first connector mounting portion”) 31 at an end on one end side in the longitudinal direction of the component (FIGS. 1 and 2). The connector 25 is physically and electrically connected to a plurality of the first wiring patterns of the first connector mounting portion 31 on the one end side of the component.

The second wiring component 40 is a flexible printed circuit board (FPC) formed in a crank shape, and has a second wiring pattern provided for each of the plurality of busbars 10 of the second busbar group 10B.

The second wiring component 40 has a connector mounting portion (hereinafter, referred to as a “second connector mounting portion”) 41 at an end on one end side of the component (FIGS. 1 and 2). The connector 25 is physically and electrically connected to a plurality of the second wiring patterns of the second connector mounting portion 41 on one end side of the component.

Here, the second connector mounting portion 41 is disposed close to the first connector mounting portion 31 on one end side of the first wiring component 30 in a facing placement direction of the first busbar group 10A and the second busbar group 10B. The first connector mounting portion 31 and the second connector mounting portion 41 are disposed side by side on an identical plane with their longitudinal directions aligned in a same direction. The wiring component 20 includes a reinforcing plate 26 to be fixed, for the reinforcement purpose, to the first connector mounting portion 31 and the second connector mounting portion 41 disposed side by side (FIGS. 1 and 2). The connector 25 is physically and electrically connected to the plurality of first wiring patterns of the first connector mounting portion 31 and the plurality of second wiring patterns of the second connector mounting portion 41 joined and reinforced by the reinforcing plate 26.

In addition, the second wiring component 40 has a main path portion 42 on the other end side, being routed with its longitudinal direction aligned with the line-up direction and provided so as to be close to the second busbar group 10B (FIGS. 1 and 2). In the main path portion 42, the busbar 10 of the adjacent second busbar group 10B is electrically connected with the second wiring pattern paired with the busbar 10. The electrical connection member physically and electrically connects the busbar 10 of the second busbar group 10B and the second wiring pattern of the main path portion 42, being connection targets, to each other.

In addition, the second wiring component 40 includes an intermediate path portion 43 connecting the second connector mounting portion 41 and the main path portion 42 to each other (FIGS. 1 and 2).

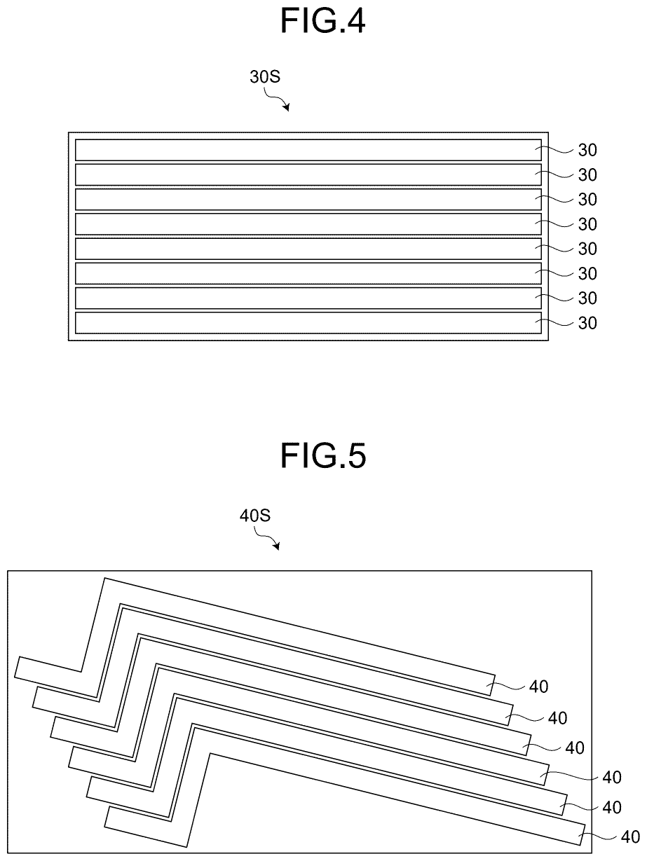

In the wiring component 20, the first wiring component 30 and the second wiring component 40 are each stamped out of one sheet to be a base material. The first wiring component 30 has a rectangular shape, and is stamped out of one rectangular sheet 30S in which the first wiring component 30 is aligned, in plurality, closed to each other (FIG. 4). Accordingly the first wiring component 30 can have the best yield at the time of stamping. On the other hand, the second wiring component 40 has a crank shape, and is stamped out of one sheet 40S in which the second wiring component 40 is aligned, in plurality, close to each other (FIG. 5). Accordingly, the yield of the second wiring component 40 at the time of stamping can be improved. Here, in order to obtain the most improved yield, the plurality of second wiring components 40 is arranged in a state where the longitudinal direction of the main path portion 42 and the like is inclined with respect to the side portion in one rectangular sheet 40S.

As described above, regarding the wiring component 20, the first wiring component 30 on the first busbar group 10A side and the second wiring component 40 on the second busbar group 10B side are formed separately. The first wiring component 30 has a rectangular shape, and thus can be formed as a component with the best yield. On the other hand, the second wiring component 40 has a crank shape, and can be formed as a component with a most improved yield under the same condition. This makes it possible to have the conductive module 1 with a good yield, with a reduced cost.

### Modification

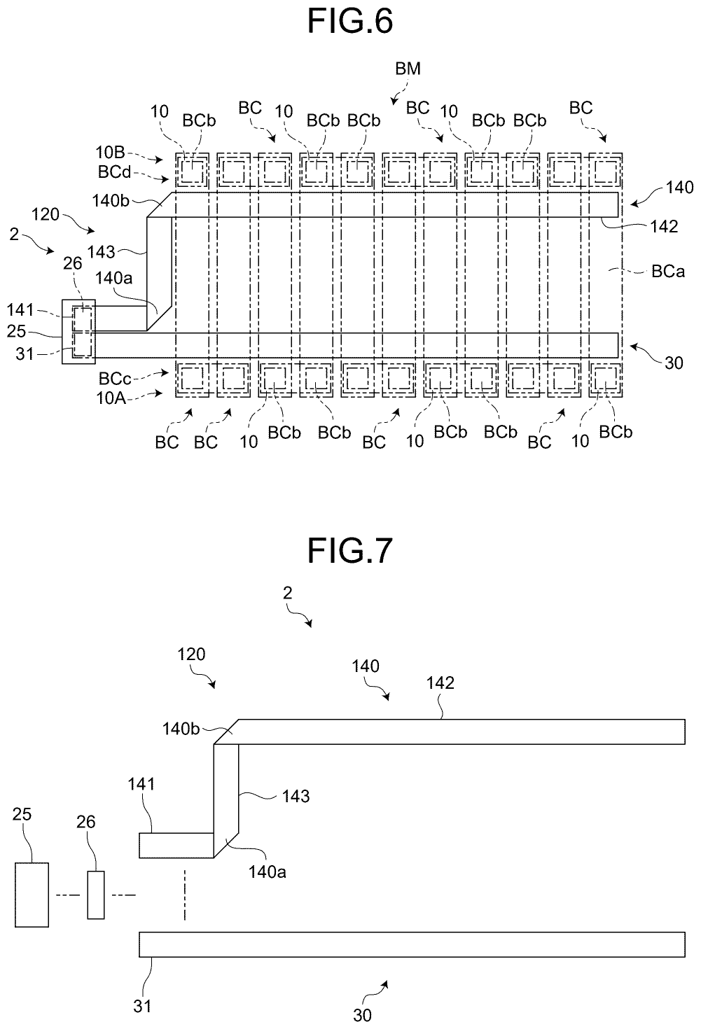

A conductive module 2 of the present modification is obtained by replacing the wiring component 20 in the conductive module 1 of the above-described embodiment with a wiring component 120 described below (FIGS. 6 and 7). In the present modification, the similar members, portions, and the like as those of the conductive module 1 of the embodiment are denoted by the same reference numerals as those of the embodiment, and the description thereof will be omitted.

The wiring component 120 of the present modification is obtained by replacing the second wiring component 40 in the wiring component 20 of the embodiment with a second wiring component 140 described below (FIGS. 6 and 7). The second wiring component 140 of the present modification is a flexible printed circuit board (FPC) formed in a rectangular shape and bent into a crank shape having two bent portions 140a and 140b, and having a second wiring pattern provided for each of the plurality of busbars 10 of the second busbar group 10B.

Similarly to the second wiring component 40 of the embodiment, the second wiring component 140 has a connector mounting portion (hereinafter, referred to as a “second connector mounting portion”) 141 at the end on one end side, and physically and electrically connects the connector 25 to the plurality of second wiring patterns of the second connector mounting portion 141 on the one end side (FIGS. 6 and 7). Similarly to the second connector mounting portion 41 of the embodiment, the second connector mounting portion 141 is disposed close to the first connector mounting portion 31 on one end side of the first wiring component 30 in the facing placement direction of the first busbar group 10A and the second busbar group 10B, and is reinforced by the reinforcing plate 26 attached, together with the first connector mounting portion 31. The connector 25 is physically and electrically connected to the plurality of first wiring patterns of the first connector mounting portion 31 and the plurality of second wiring patterns of the second connector mounting portion 141 joined and reinforced by the reinforcing plate 26.

In addition, similarly to the second wiring component 40 of the embodiment, the second wiring component 140 has a main path portion 142 on the other end side, being routed with its longitudinal direction aligned with the line-up direction and being provided so as to be close to the second busbar group 10B (FIGS. 6 and 7). In the main path portion 142, the busbar 10 of the adjacent second busbar group 10B is electrically connected with the second wiring pattern paired with the busbar 10. The electrical connection member physically and electrically connects the busbar 10 of the second busbar group 10B and the second wiring pattern of the main path portion 142. being connection targets, to each other.

In addition, the second wiring component 40 includes an intermediate path portion 143 connecting the second connector mounting portion 141 and the main path portion 142 via the two bent portions 140a and 140b (FIGS. 6 and 7).

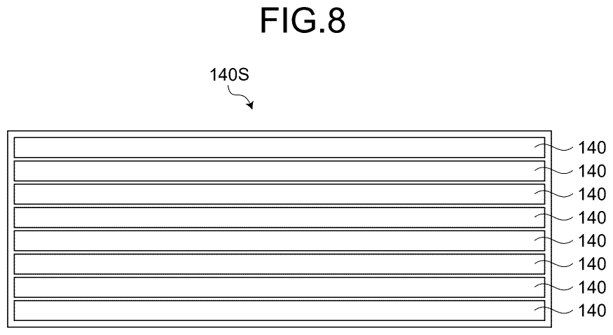

In the wiring component 120 of the present modification, not only the first wiring component 30 but also the second wiring component 140 is formed in a rectangular shape. Therefore, similarly to the first wiring component 30, the second wiring component 140 of the present modification can be stamped out of one rectangular sheet 140S in which a plurality of the second wiring components 140 are arranged side by side, making it possible to obtain the best yield in the stamping (FIG. 8).

As described above, similarly to the wiring component 20 of the embodiment, the wiring component 120 of the present modification has a configuration in which the first wiring component 30 on the first busbar group 10A side and the second wiring component 140 on the second busbar group 10B side are formed separately. In the wiring component 120 of the present modification, both the first wiring component 30 and the second wiring component 140 have a rectangular shape, and thus can be stamped in the rectangular shape respectively out of the sheets 30S and 140S, making it possible to form each as a component with the best yield. Accordingly, the conductive module 2 of the present modification can be the best in terms of yield as compared with the conductive module 1 of the embodiment.

Here, while being formed in a rectangular shape, the second wiring component 140 of the present modification has two bent portions. Therefore, here, it is desirable to compare the cost of the second wiring component 140 in consideration of the bending process and the cost of the second wiring component 40 of the embodiment and to adopt the component that can be formed with the lower cost.

In the conductive module according to the present embodiment, the wiring component is provided to include separately formed components, namely, a first wiring component on a first busbar group side and a second wiring component on a second busbar group side. The first wiring component has a rectangular shape, and thus can be formed as a component with the best yield. On the other hand, the second wiring component has a crank shape, and can be formed as a component with a most improved yield within the range. Consequently, the conductive module according to the present embodiment will achieve a good yield.

In addition, in the conductive module according to the present embodiment, the wiring component is provided to include separately formed components, namely, the first wiring component on the first busbar group side and the second wiring component on the second busbar group side. This wiring component includes the first wiring component and the second wiring component each having a rectangular shape, making it possible to form each of these as a component with the best yield. Consequently, the conductive module according to the present embodiment will be the best in yield.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A conductive module comprising:
busbar groups, each group being an aggregate of busbars, the busbar being provided to physically and electrically connect to an electrode terminal of a battery cell constituting a battery module, the busbar groups including a first busbar group having, as a connection target, a plurality of the electrode terminals on one side arranged in a line-up direction of a plurality of the battery cells constituting the battery module and a second busbar group having, as a connection target, a plurality of the electrode terminals on the other side arranged in the line-up direction;
a wiring component to electrically connect the busbar to a battery monitoring unit that monitors a battery state of the battery cell; and
an electrical connection member for each busbar to physically and electrically connect the wiring component to the busbar, wherein
the wiring component includes: a first wiring component being a flexible printed circuit board formed in a rectangular shape and having a first wiring pattern provided for each of the plurality of busbars of the first busbar group; a second wiring component being a flexible printed circuit board formed in a crank shape and having a second wiring pattern provided for each of the plurality of busbars of the second busbar group; and a connector for connecting the first wiring component and the second wiring component to the battery monitoring unit by using the connector,
the first wiring component is routed so as to allow its longitudinal direction to be aligned with the line-up direction and to be close to the first busbar group while maintaining the rectangular shape, and
the second wiring component includes: a second connector mounting portion on one end side provided so as to be close to a first connector mounting portion on one end side of the first wiring component in a facing placement direction of the first busbar group and the second busbar group; a main path portion on the other end side routed so as to set its longitudinal direction to be aligned with the line-up direction and to be close to the second busbar group; and an intermediate path portion to connect the second connector mounting portion and the main path portion.

2. A conductive module comprising:
busbar groups, each group being an aggregate of busbars, the busbar being provided to physically and electrically connect to an electrode terminal of a battery cell constituting a battery module, the busbar group including a first busbar group having, as a connection target, a plurality of the electrode terminals on one side arranged in a line-up direction of a plurality of the battery cells constituting the battery module and a second busbar group having, as a connection target, a plurality of the electrode terminals on the other side arranged in the line-up direction;
a wiring component to electrically connect the busbar to a battery monitoring unit that monitors a battery state of the battery cell; and
an electrical connection member for each busbar to physically and electrically connect the wiring component to the busbar, wherein
the wiring component includes: a first wiring component being a flexible printed circuit board formed in a rectangular shape and having a first wiring pattern provided for each of the plurality of busbars of the first busbar group; a second wiring component being a flexible printed circuit board formed in a rectangular shape and bent in a crank shape having two bent portions and having a second wiring pattern provided for each of the plurality of busbars of the second busbar group; and a connector for connecting the first wiring component and the second wiring component to the battery monitoring unit by using the connector,
the first wiring component is routed so as to allow its longitudinal direction to be aligned with the line-up direction and to be close to the first busbar group while maintaining the rectangular shape, and
the second wiring component includes: a second connector mounting portion on one end side provided so as to be close to a first connector mounting portion on one end side of the first wiring component in a facing placement direction of the first busbar group and the second busbar group; a main path portion on the other end side routed so as to set its longitudinal direction to be aligned with the line-up direction and to be close to the second busbar group; and an intermediate path portion to connect the second connector mounting portion and the main path portion via the two bent portions.

3. The conductive module according to claim 1, wherein
the connector is physically and electrically connected to a plurality of the first wiring patterns of the first connector mounting portion and to a plurality of the second wiring patterns of the second connector mounting portion.

4. The conductive module according to claim 2, wherein
the connector is physically and electrically connected to a plurality of the first wiring patterns of the first connector mounting portion and to a plurality of the second wiring patterns of the second connector mounting portion.

5. The conductive module according to claim 3, wherein
the wiring component includes a reinforcing plate that is attached to and reinforces the first connector mounting portion and the second connector mounting portion.

6. The conductive module according to claim 4, wherein
the wiring component includes a reinforcing plate that is attached to and reinforces the first connector mounting portion and the second connector mounting portion.

7. The conductive module according to claim 1, wherein
the electrical connection member physically and electrically connects the busbar of the first busbar group and the first wiring pattern, being connection targets, or physically and electrically connects the busbar of the second busbar group and the second wiring pattern of the main path portion, being connection targets.

8. The conductive module according to claim 2, wherein
the electrical connection member physically and electrically connects the busbar of the first busbar group and the first wiring pattern, being connection targets, or physically and electrically connects the busbar of the second busbar group and the second wiring pattern of the main path portion, being connection targets.
